(19) United States
(12) Patent Application Publication
(10) Pub. No.: US 2015/0110688 A1
(43) Pub. Date: Apr. 23, 2015

(54) CHANNEL DEVICE AND METHOD FOR FABRICATING THE SAME

(71) Applicant: CANON KABUSHIKI KAISHA, Tokyo (JP)

(72) Inventor: Eishi Igata, Utsunomiya-shi (JP)

(21) Appl. No.: 14/514,773

(22) Filed: Oct. 15, 2014

(30) Foreign Application Priority Data
Oct. 17, 2013 (JP) 2013-216665

(51) Int. Cl. B01L 3/00; B32B 37/12; B32B 37/18; B32B 37/10

(52) U.S. Cl. CPC B01L 3/502707; B32B 37/10; B32B 37/1284; B32B 37/18; B32B 2037/1253; B32B 2333/12; B32B 2439/00; B01L 2300/0887; B01L 2300/0861; B01L 2200/12; B01L 2300/0816
USPC 422/502; 156/60; 156/64

(57) ABSTRACT

A method for fabricating a channel device that is formed by bonding a first substrate having a first adhesion surface to a second substrate having a second adhesion surface, the second adhesion surface having a plurality of grooves that become channel wall surfaces, the method including a first step of forming a layer of a liquid composed of a curable adhesive between the first adhesion surface and the second adhesion surface; a second step of forming menisci of the liquid in the vicinities of wall surfaces of the plurality of grooves after the first step by applying a pressure to bring the first adhesion surface and the second adhesion surface close to each other; and a third step of curing the adhesive while the first adhesion surface and the second adhesion surface are close to each other.

### BACKGROUND

1. Field of the Invention

The present invention relates to a method for fabricating a channel device having a plurality of channels.

2. Description of the Related Art

It is fundamental in analytical chemistry that desired information such as concentration, composition, and other information be obtained in order to confirm the progress or the result of a chemical or biochemical reaction. Various devices and sensors have been invented with the aim of acquiring such information. There is a concept called a micro total analysis system (μ-TAS) or a Lab-On-A-Chip, in which the above devices and sensors are micronized, aiming at implementing the whole process on a micro device until the desired information is obtained. The goal of this concept is to obtain, for example, the final concentration of a component contained in a chemical compound or a specimen that is obtained after going through processes such as purification and chemical reaction by passing the collected material or unpurified specimen through a channel inside the device. Furthermore, a minute amount of solution or gas is necessarily used in a channel device conducting such an analysis and causing such a reaction; accordingly, the device is often called a microchannel device or a microfluidic device.

Compared with a desktop-sized analyzer of the known art, when a microchannel device is used, the amount of fluid included in the device is smaller; accordingly, it is expected that reaction time can be shortened due to reduction in the required amount of reagent and the minute analyte amount. As the above-described advantages of the microchannel device has become acknowledged, attention has been attracted towards the technique related to μ-TAS.

Typically, a microchannel device is configured by bonding a substrate having grooves in its surface to a flat plate that becomes a top wall or a bottom wall of the channels. The method of bonding the substrates to each other includes, for example, thermal welding, anode bonding, ultrasonic bonding, crimping after irradiation of an excimer laser beam, and crimping after the substrate surfaces are softened with a solvent. Furthermore, there has been an attempt to carry out a bonding method that uses an adhesion layer in which various ideas have been devised (Japanese Patent Laid-Open No. 2004-136637, FIG. 1).

Japanese Patent Laid-Open No. 2004-136637 discloses a microchannel device to which bonding has been carried out using an adhesive. A micro groove (concavity) is formed in a surface of a plate and a sealing surface is formed so as to surround the micro groove. A partition groove that is recessed with respect to the sealing surface is formed around the sealing surface, and a cover member fixing surface is formed outside the partition groove so as to surround the sealing surface. It is further described that a cover member is adhered and fixed to the cover member fixing surface and that a filling material is made to permeate through a microgap between the sealing surface of the plate and the cover member by capillarity.

In other words, the method for fabricating the micro channel described in Japanese Patent Laid-Open No. 2004-136637 is a method in which a partition groove serving as a barrier of the adhesive is provided around the groove such that the groove that is to be a channel is not filled with adhesive and in which the outer periphery of the partition groove is bonded with an adhesive. Furthermore, another filling material is filled into the inner periphery of the partition groove to fill the gap by capillarity such that a channel is formed.

As described above, in the fabrication method described in Japanese Patent Laid-Open No. 2004-136637, the adhesive is made to permeate through the gap between two substrates by capillarity. After permeation of the adhesive into the gap is completed, the microchannel is formed by curing the adhesive by irradiating ultraviolet rays onto the adhesive.

However, it is difficult to accurately estimate the distance of the gap between the substrates when the two substrates are brought in contact with each other; accordingly, the amount of adhesive to be fed into the gap cannot be estimated accurately.

Accordingly, as a measure to respond to the problem of excessive adhesive, which has been filled into the gap, filling up the channel, a partition groove that may be filled up is provided. However, with this method, when a plurality of channels through which a solution passes are arranged, a partition groove that will receive the adhesive needs to be fabricated around each channel, which becomes an obstacle when integrating the plurality of channels.

### SUMMARY

The present disclosure provides a channel device, in which a plurality of channels are integrated, that can be manufactured by a simple method using an adhesive and that has no adhesive filling the channels.

A method for fabricating a channel device according to the present disclosure is

a method for fabricating a channel device that is formed by bonding a first substrate having a first adhesion surface to a second substrate having a second adhesion surface, the second adhesion surface having a plurality of grooves, the method including

a step of forming a layer of a liquid composed of a curable adhesive between the first adhesion surface and the second adhesion surface,

a step of applying a pressure to bring the first adhesion surface and the second adhesion surface close to each other such that a meniscus of the liquid is formed in a vicinity of a wall surface of the plurality of grooves, and

a step of curing the adhesive while the first adhesion surface and the second adhesion surface are close to each other.

The present disclosure can provide a channel device having a plurality of channels, in which an adhesive filling the channels is reduced, with a simple fabrication method.

Further features of the present invention will become apparent from the following description of exemplary embodiments with reference to the attached drawings.

### BRIEF DESCRIPTION OF THE DRAWINGS

FIG. 1 is a conceptual diagram illustrating a principal concept disclosed herein.

FIG. 2 is a cross-sectional view for describing the principal concept disclosed herein.

FIG. 3 is a mode of a device.

FIG. 4 is a result of an experiment performed on a mode of a device disclosed herein.

FIG. 5 is a mode of a device disclosed herein.

FIGS. 6A and 6B describe distances from the channel walls.

FIG. 7 is a mode that includes concavities and convexities in the adhesion surface.

### DESCRIPTION OF THE EMBODIMENTS

Hereinafter, the present invention will be described in detail.

A fabrication method for a channel device according to the present disclosure to overcome the above problem is a method for fabricating a channel device that is formed by bonding a first substrate having a first adhesion surface to a second substrate having a second adhesion surface, the second adhesion surface having a plurality of grooves, the method including a first step of forming a layer of a liquid composed of curable adhesive between the first adhesion surface and the second adhesion surface, a second step of forming menisci of the liquid in the vicinities of wall surfaces of each of the plurality of grooves after the first step by applying pressure to bring the first adhesion surface and the second adhesion surface close to each other, and a third step of curing the adhesive while the first adhesion surface and the second adhesion surface are close to each other.

As a result of an intensive study, the inventors have found that, as will be described in detail hereinafter, the filling volume of the adhesive in the channels is correlated with the interval at which the channels are arranged, the viscosity of the adhesive that is used, and the load (pressure) that is applied between two sides that overlap each other, and, further, it has been found that by adjusting the above, the adhesive does not flow into the channels and it is possible to form menisci of the adhesive in the vicinities of the wall surfaces of the channels, that is, it is possible to create a balance.

In other words, it has been found that by forming a layer of a liquid composed of curable adhesive between the first adhesion surface and the second adhesion surface, and after that, by applying pressure so that the first adhesion surface and the second adhesion surface are brought close to each other, menisci of the liquid are formed in the vicinities of the wall surfaces of the plurality of grooves; accordingly, a channel device in which no adhesive flows into the channels can be provided.

Methods for “applying pressure so that the first adhesion surface and the second adhesion surface are brought close to each other so as to form menisci of the liquid in the vicinities of the wall surfaces of the plurality of grooves” include, as will be described hereinafter, a method in which pressure is applied after the pressure to be loaded is determined in advance by a calculation formula and a method in which pressure is gradually increased while the spreading state of the adhesive is directly observed. The method based on the calculation formula is desirable since the method can be carried out in a device that is arranged with a shielding member and the like that does not allow the spreading of the liquid to be directly observed.

A feature of the present embodiment is that a channel device having a substrate surface coated with an adhesion layer and a substrate surface having a plurality of grooves, which are not connected to one another, bonded to each other by applying pressure to the substrates with the adhesion layer therebetween includes hollow channels and arranges the plurality of channels such that the following Expression (1) is satisfied:

$$L < \frac{{L}_{R} {W}_{D}^{2}}{( M + m ) g} \frac{T cos θ}{d} ,$$

where L is the distance from a channel wall to a discrete point, d is the coating thickness of the adhesion layer, T is the surface tension of a material of the adhesion layer, θ is the contact angle between the material and a substrate surface, M is the mass of a piece for applying pressure, L_{R} is the width of the piece, m is the mass of the substrate, W_{D} is the width of the device, and g is the gravitational acceleration.

The material of a first substrate and that of a second substrate may be glass, plastic, silicon, ceramic, or the like. The width of the grooves may be about a few micrometers to about 1 mm. The fabrication method of the grooves greatly depends on the material. For example, if the material is silicon or glass, microfabrication using photolithography may be performed, and if the material is plastic, injection molding, hot embossing, or drilling may be performed; however, the fabrication method is not limited to these methods in particular.

The adhesive may be any that can form a liquid layer and may be, for example, a UV curable adhesive, a thermosetting adhesive, or an adhesive that is a mixture of two adhesives. Considering the affinity with the substrate, an adhesive that can be coated uniformly with a thickness of a few micrometers is desirable. For example, if the substrate is formed of glass, which is hydrophilic, it is desirable that the adhesive be hydrophilic as well. Among the adhesives, a UV curable adhesive in particular has an advantage in its fast cure rate. However, since UV rays need to be irradiated through the substrate, the dose of UV absorbed in the substrate is small and the thickness of the substrate is limited.

Regarding the application of pressure, pressure is not applied intensively to only a single point of the channel device but is applied across the whole width of the device. If the application of load is biased to just one point, the distances between the substrate surfaces will be affected during the pressure applying process; accordingly, pressure is applied across the whole width of the device in order to avert this.

Regarding the thickness of the adhesion layer when the plurality of substrates are bonded to each other with the adhesion layer in between, as will be described in detail later, a thickness of about a few micrometers is desirable to carry out bonding without clogging the microchannels that each have a depth of a few ten to a few hundred micrometers. In order to obtain the above thickness, there are methods such as spin coating, spray coating, dip coating, and printing, in which the adhesive is dissolved in a solvent; however, the method is not limited to these methods in particular.

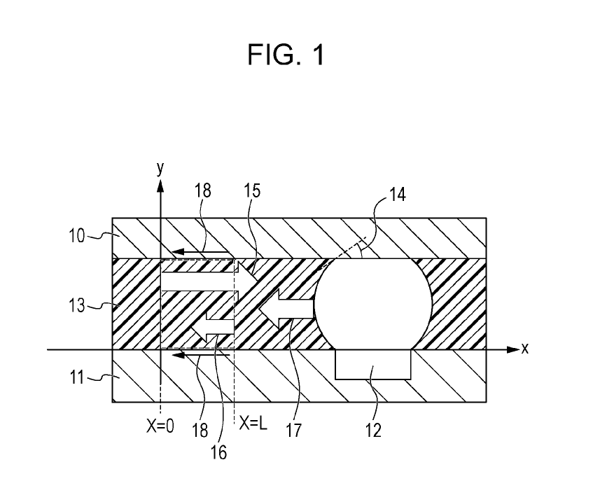

FIG. 1 illustrates a cross-section of an uncured adhesive in the vicinity of a channel when a hollow channel is formed using an adhesive. There is a substrate 10 and a substrate 11 that has a groove 12 in its surface. A contact angle 14 is maintained between an adhesive 13 and the substrate 10. After the substrates 10 and 11 are bonded to each other with the adhesive 13 so as to be substantially parallel to each other, the groove 12 will be referred to as a channel 12. Note that two-dimensional orthogonal coordinate axes have an origin that is illustrated in FIG. 1. At this point, in a minute area defined between a position where x=0 and a position where x=L, when the adhesive 13 is moving towards the channel 12 at a constant velocity, a force F(15) acts towards the channel 12 and a force F₀(16) acts as a reaction to the force F(15) at the position where x=L. Furthermore, a frictional force f(18) acts on a boundary surface between the adhesive 13 and each of the substrates 10 and 11. The above is expressed by the following expression.

F−F₀−f. (2)

Meanwhile, at the boundary surface between the adhesive 13 and the channel 12, a surface tension ST(17) of the adhesive 13 that is oriented in a direction countering the flow of the adhesive 13 is imposed. If the surface tension ST(17) is larger than the total force causing the adhesive 13 to flow, then no adhesive 13 will enter the channel 12. Accordingly, the condition for not allowing the adhesive 13 to fill the channel 12 is as follows.

F−F₀−f<ST. (3)

If p₀ is the force per unit area at a position where x=0, then

F=p₀dw, (4)

where d is the coating thickness of the adhesive 13, w is the length of the adhesive layer in the direction that is perpendicular to the sheet surface. Next, if p_{L}, is the force per unit area at a position where X=L, then

F₀=−p_{L}dw=−{p₀+(dp/dx)L}dw=−{p₀−aL}dw. (5)

In the above, a is −dp/dx and −dp/dx is the pressure gradient. Since the frictional force f is proportional to the velocity of the adhesive 13, the frictional force f can be expressed as follows:

f=2wLμ(du/dy), (6)

where u is the velocity of the adhesive 13 flowing in the x direction and μ is the viscosity of the adhesive 13 before the adhesive 13 is cured. A velocity profile of a fluid that flows between parallel substrates plots a parabolic profile in which the peak is the midpoint of the substrates. The frictional force f between parallel substrates is given by

f=−μ(8wLU₀/d), (7)

where U₀ is the maximum velocity in the velocity profile, that is, U₀=ad²/8μ.

Furthermore, the surface tension ST (the arrow 17 in FIG. 1) that is imposed in the channel 12 and in the adhesive 13 is given by

ST=2wT cos θ, (8)

where T is the surface tension of the adhesive 13.

Finally, when the above are substituted into F−F₀−f<ST to solve for d, then, the following is obtained:

$$d < \frac{T cos θ + V \overline{{( T cos θ )}^{2} + aL \cdot 8 μ {U}_{0} L}}{aL} .$$

Note that the viscosity of the adhesive 13 is generally a few hundred mPa·s or more which is much greater than 1 mPa·s that is the viscosity of water. In actuality, the flow velocity of the adhesive 13 when the substrates 10 and 11 are bonded to each other with the adhesive 13 in between is extremely low such that U₀ approximates 0. In such a case, the above Expression 9 is given as follows:

d<2T cos θ/(aL). (10)

As regards the channel being filled with the adhesive, it can be understood that the coating thickness of the adhesive and the distance from the channel have an inversely proportional relationship.

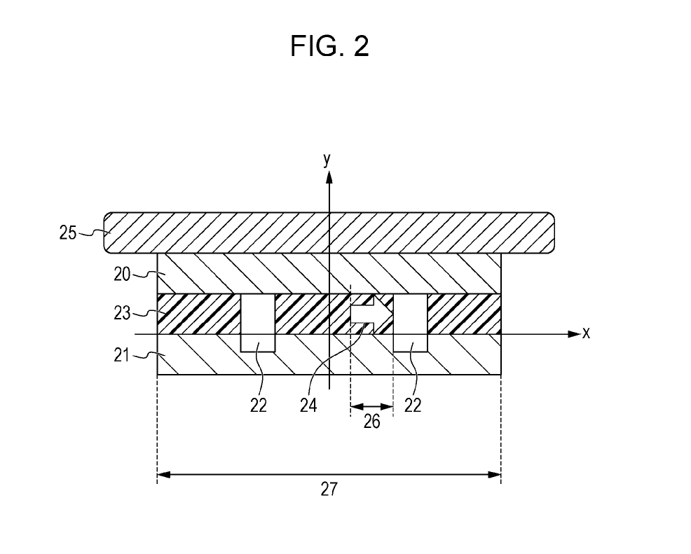

Furthermore, the pressure gradient a is a gradient of the pressure generated when substrates 20 and 21 are applied pressure and are bonded to each other as illustrated in FIG. 2. Assuming that pressure propagates in an isotropic manner inside an adhesive 23, a pressure p₀(24) that is the pressure acting in the x axis direction upon application of pressure can be calculated by the following equation:

$${p}_{0} = \frac{2 ( M + m ) g}{{L}_{R} {W}_{D}} \frac{L ( x )}{{W}_{D}} ,$$

where M is the weight of a weight 25, m is the weight of the substrate 20, g is the gravitational acceleration, L_{R} is the length in which the weight 25 and the substrate 20 are in contact with each other in the direction that is perpendicular to the sheet surface, W_{D}(27) is the overall width of the channel device, and L(x) (26) is the distance from the wall of a channel 22. In the above equation for p₀, the first term is the force of the weight 25 and the substrate 20 divided by the contact area L_{R}W_{D} of the weight 25 and the substrate 20. Note that the coefficient 2 is the sum of the force of the pressure applied to the substrate 20 and the force from the substrate 21 as a reaction to the force of the pressure applied to the substrate 20. Furthermore, the second term expresses the ratio of the distance L(x) from the wall of a channel 22 to the overall width W_{D} of the channel device. Accordingly, the following can be obtained:

a=−dp₀/dx=2(M+m)g/(L_{R}W_{D}²). (12)

Finally, substituting the above into d<2T cos θ/(aL) gives

$$d < \frac{{L}_{R} {W}_{D}^{2}}{( M + m ) g} \frac{T cos θ}{L ( x )} .$$

All the values included in the above Expression (13) can be controlled. It can be appreciated from the above Expression (13) that the coating thickness d of the adhesive and the distance L(x) from the channel wall have an inversely proportional relationship; accordingly, if L(x) is increased, d needs to be reduced or otherwise the adhesive will enter the channel.

Conversely, even if the coating thickness d of the adhesive is set large, by keeping the distance L(x) from the wall of the channel at or under a specific length, the device can be designed so that no adhesive fills the channel. In other words, when the distance between a wall of a channel and a wall of another channel adjacent to the wall of the channel is small and when a condition defined by Expression (13) is satisfied, no adhesive enters any channel and there is no need to provide a channel, which may be filled with the adhesive, that surrounds the periphery of each channel.

Therefore, a microchannel device is formed by bonding without having any adhesive enter the channels by designing channels that satisfies the following expression:

$$L < \frac{{L}_{R} {W}_{D}^{2}}{( M + m ) g} \frac{T cos θ}{d} .$$

Channels into which no adhesive flows can be devised by arranging the plurality of channels parallel to one another in a dense manner so that the above relationship is satisfied.

Furthermore, since the above requirements can be easily met, at least one hollow groove can be arranged outside the outermost channels of the channels arranged in parallel. Alternatively, at least one hollow groove can be arranged in the end portion of the substrate such that the above relationship is maintained.

In the present embodiment, both ends of the channels are provided with openings for supplying and discharging a liquid and when at least one hollow groove that is not used as a channel is provided, no solution needs to flow in this at least one hollow groove at the outermost portion; accordingly no opening needs to be provided at the two ends of the at least one hollow groove. Furthermore, the shape of the at least one hollow groove at the outermost portion does not need to be the same as that of the channels.

Furthermore, in order to provide the plurality of channels described above, it is desirable that the plurality of grooves include a plurality of channels to pass liquid therethrough that include openings at the two ends thereof and at least one hollow groove portion that has no openings at the two ends thereof. In other words, it is desirable that grooves that are to be channels and at least one groove that may be filled up coexist.

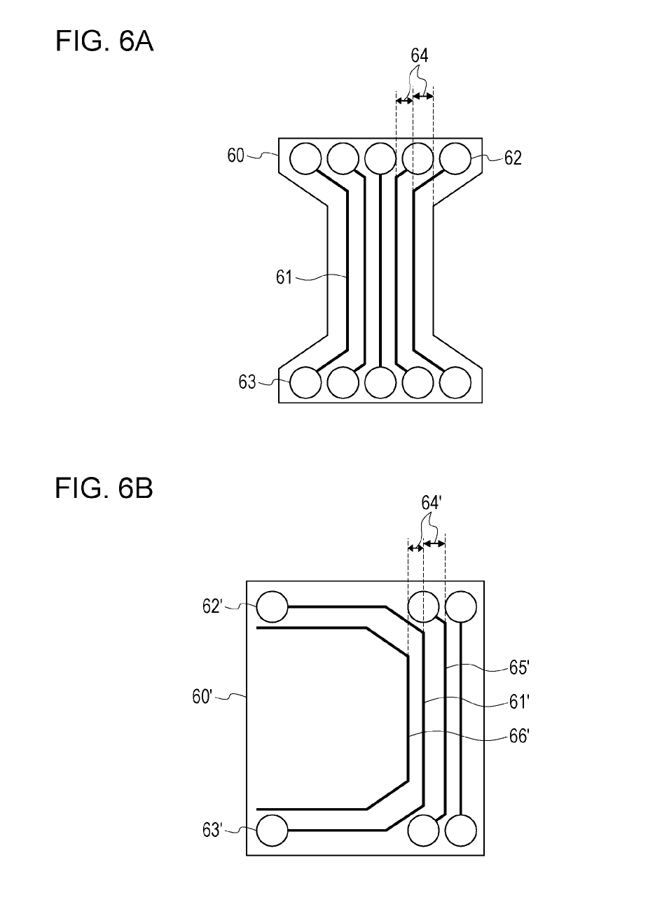

In particular, as in the system illustrated in FIG. 6B described later, a system that includes an area in which a plurality of channels are arranged parallel to one another in a dense manner and an area in which the channel arrangement is sparse can prevent an adhesive from entering the channels from the sparse area by providing at least one hollow groove between the sparse area and the channels; accordingly, a suitable channel device may be fabricated readily.

Another embodiment is an embodiment that forms menisci of the liquid in the vicinities of the wall surfaces of the plurality of grooves while the spreading of the adhesive caused by the application of pressure is observed.

Similar to the first embodiment, a liquid layer composed of curable adhesive is formed between the first adhesion surface and the second adhesion surface.

Different from the first embodiment, when pressure is applied to bring the first adhesion surface and the second adhesion surface close to each other, menisci are formed in the vicinities of the wall surfaces of the channels by increasing the pressure in a gradual manner while the spreading state of the adhesive is observed directly.

The observation may be carried out visually or through an observation device, such as a CCD camera.

In the present embodiment, since a load M, when applying pressure, can be changed selectively, the balanced position can be easily found out without strictly setting the distance between the channels, which is a parameter of the formula described above.

As for the process after the above, the adhesive is cured in a similar manner to that of the first embodiment; accordingly, a channel device formed with a plurality of suitable channels can be fabricated.

### EXAMPLES

Hereinafter, the present invention will be described more specifically with the examples. Note that the examples described below are examples for describing the present invention in further detail and the embodiments are not limited to the examples below.

### Example 1

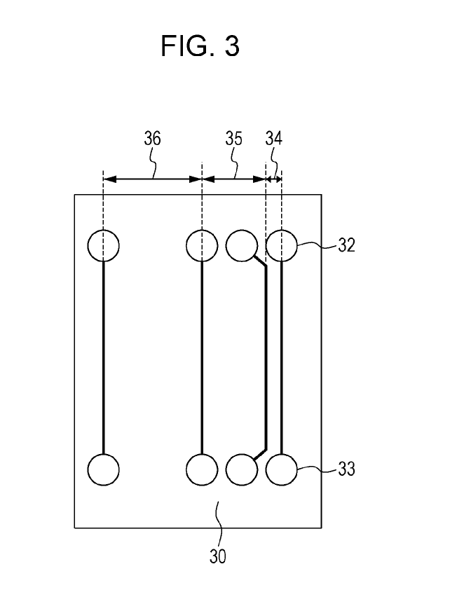

As illustrated in FIG. 3, a plurality of grooves that were to become portions of the wall surfaces of the channels were molded on the surface of a substrate 30 composed of PMMA. A channel device having hollow channels were fabricated by bonding a flat plate-shaped PMMA substrate to the substrate 30. A plurality of substrates 30 in which the distance between the grooves were variously changed were formed so that the difference in distribution of the adhesive in relation to the interval at which the grooves were arranged could be observed.

The channel width of each channel was 100 μm, the channel height of each channel was 50 μm. Injection holes 32 and spouting holes 33 of a solution, the injection holes 32 and spouting holes having a diameter of 1 mm, were formed in the substrates 30.

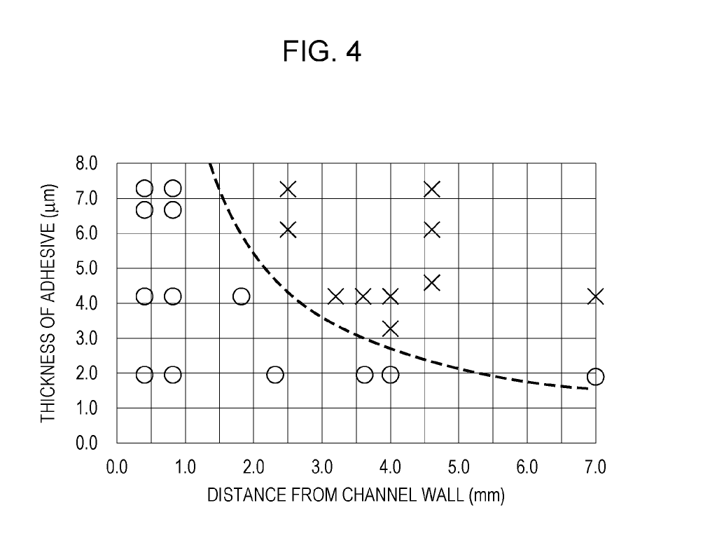

Distances 34, 35, and 36 that are each a distance from a wall of a channel to a wall of another adjacent channel were, for example, 0.4 mm, 1.7 mm, and 2.5 mm, respectively. Note that FIG. 3 is a conceptual diagram and further detailed distances and further detailed coating thicknesses of the adhesive are illustrated in the graph of FIG. 4.

An ultraviolet curing resin named World Rock 5541 (registered trademark, manufactured by Kyoritsu Chemical & Co., Ltd., viscosity 2000 mPa·s) was used as the adhesive. The adhesive was coated to a thickness ranging from about 2 to about 7 μm on the substrate 30, the substrate 30 and the flat plate-shaped substrate was bonded together, and a weight was placed thereon to apply pressure thereto. Then, a dose of about 3000 mJ/cm² of ultraviolet rays was irradiated at an irradiation density of 50 mW/cm² to cure the adhesive. Finally, the channels after irradiation of the ultraviolet rays were observed with a microscope to observe whether there were any adhesive that entered the channels.

FIG. 4 illustrates a broken line plotted on a graph, the broken line being the calculation result after substituting, into Expression (1), the contact angle (θ, 36°) between the adhesive used in the present example and the substrate, the overall width (W_{D}), 40 mm) of the device, the contact length (L_{R}, 1 mm) of the weight and the substrate, the weight of the weight (M, 610 g), the weight of the substrate (m, 1.3 g), and the surface tension (T, 50 mN/m) of the adhesive. Furthermore, in the present example, an observation was carried out with a microscope and values in which the adhesive entered the channel was plotted with a mark X and values in which no adhesive entered the channel was plotted with a mark O.

FIG. 4 was consistent with Expression (1). The longer the distance was from the channel wall, the coating thickness of the adhesive needed to be smaller, otherwise, the adhesive easily entered the channel. Furthermore, it was verified that the shorter the distance was from the channel wall, the easier it was to prevent the adhesive from entering the channel. Additionally, when the thickness of the adhesive was 1 μm or under, even if the distance from the channel wall was 7.0 mm or more, no adhesive entered the channel; however, spaces, a representative example of which are burrs, that are formed by concavities and convexities produced during molding were observed.

Note that when coating the adhesive onto the substrate 30, there were cases in which the adhesive coated the channels; however, the thickness of the adhesive was only about 7 μm at the most and no problem was encountered while the channel device was used.

As described above, it has been understood from the present example that by arranging a channel in an area that is short in distance from a wall of an adjacent channel, the adhesive was prevented from entering the channel and there was no need to form a channel that may be filled up with the adhesive.

### Example 2

In Example 2, a substrate 51 similar to that of Example 1 was used and was bonded with a flat plate-shaped substrate coated with an adhesive.

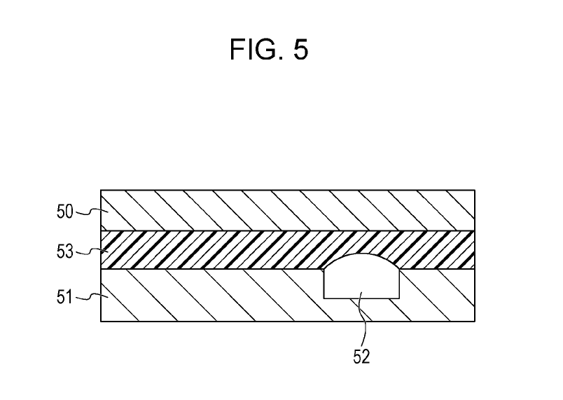

FIG. 5 illustrates a state in which the substrate 51 including a channel 52 was bonded with a flat plate-shaped substrate 50 after the flat plate-shaped substrate 50 had been coated with an adhesive 53. Due to the pressure applied during bonding, the internal pressure in the adhesive 53 was increased, and the pressure passed out from the lateral sides of the substrate or from the channel 52. Whether the adhesive 53 enters the channel 52 is determined by the relationship between the pressure and the surface tension at the boundary surface between the adhesive 53 and the channel 52.

The verification result of the present example also showed a substantially similar result to that illustrated in FIG. 4 since occurrence of internal pressure and resistance of the adhesive, which was created by the surface tension, against flowing down into the channel were seen that were similar to when verification was carried out in Example 1. Furthermore, six channels each maintaining a distance of 0.4 mm from the wall of a corresponding channel were fabricated and bonding was carried out with an adhesive; no adhesive entering the channels were observed.

Since the microchannels can be fabricated by coating the adhesive onto the flat plate-shaped substrate, application of the adhesive to the substrate surface can be simplified. For example, by dissolving the adhesive in a solvent as required and by spin coating, spray coating, or dip coating the adhesive solution, it will be possible to uniformly coat a few micrometers of adhesive on the substrate surface. Meanwhile, as is the case of Example 1, when coating the adhesive onto the substrate 51, a way to prevent the adhesive from coating the inside of the groove 52 and a way to uniformly coat the adhesive onto the areas around the groove and the holes need to be worked out.

### Example 3

As Example 3, an example will be described in which the channels are designed so as to maintain a short distance from the channel walls such that the throughput of the channel device is increased.

A principal of the present invention is to maintain a state in which a force acting inside an adhesive is smaller than a surface tension of the adhesive that is imposed in the vicinity of a relative channel. Other than the vicinity of the channels, a portion where surface tension is generated is the vicinity of the outer periphery of the channel device. Accordingly, the relationship expressed by Expression (2) can be made to hold true in the vicinity of the outer periphery of the channel device. However, if the surface tension generated in the vicinity of the outer periphery of the channel device is smaller than the force created inside the adhesive, then, the adhesive does not enter the channels but flows out to the lateral surfaces of the channel device.

The outer periphery of the channel device being present at a short distance from the walls of the channels leads to an effective use of the area of the channel device. That is, it will be a channel design in which channels cover the entire area of the channel device resulting in downsizing of the channel device.

A microchannel device according to FIG. 6A includes channels 61, injection ports 62, and spouting ports 63. The channel device is designed such that the distance between the wall of the channel that is closest to an outer periphery 60 and the outer periphery 60 is the same as the distance 64 between a wall of a channel and a wall of another adjacent channel. If the distances from the channel walls are all made to satisfy Expression (2), it will be possible to reduce the adhesive entering the channels when bonding is carried out with the adhesive. By downsizing the channel device in accordance with the shapes of the channels, the created space can be utilized to pass a tube therethrough for connecting an external device such as a pump to the channel device, for example.

Furthermore, a channel design such as the one in FIG. 6B can be conceived in order to reduce the adhesive entering the channels while the shape of the channel device is maintained. The channel device 60′ includes channels 61′ and 65′, injection ports 62′, and spouting ports 63′. A measure for when one of the ejection ports and one of the spouting ports need to be positioned at 62′ and 63′ depicted in FIG. 6B, respectively, and for when the shape of the channel device 60′ needs to be maintained, for example, will be described. The channel 61′ of FIG. 6B includes a channel that extends towards the injection port 62′ side and a channel that extends towards the spouting port 63′ side, the distance of each channel from the wall of the corresponding channel being large such that Expression (1) is not satisfied. Accordingly, in order to reduce the adhesive entering the channel, a channel 66′ is fabricated on the other side of the channel 61′ with respect to the channel 65′ at a distance 64′ that is the same as the distance between the channels 61′ and 65′. Although no solution flows through the channel 66′, the channel 66′ has a function of reducing the adhesive entering the channel 61′ when the plate is bonded with the adhesive. Furthermore, as for the portion of the channel near the outer periphery of the channel device 60′, even if the channel through which no solution flows is not provided, since the portion of the channel is sufficiently close to the outer periphery, Expression (1) is satisfied.

Such as the present example, by arranging a plurality of channels in a single device, the throughput of the specimen increases; accordingly, the throughput of the analysis is improved.

### Example 4

Example 4 of the present invention will be described. In the example, the device has channels arranged at short distances from the channel walls and corresponds to the surface configuration of the adhesion member.

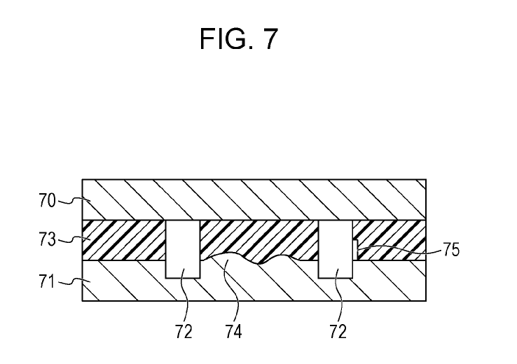

Referring to FIG. 7, a substrate 71 having grooves 72 on its surface and a substrate 70 are bonded together with an adhesive 73. There exist a concavo-convex shape 74 and a machining mark 75 on the surface of the substrate 71. As can be understood from FIG. 4, typically, when bonding with an adhesive, the thinner the coating thickness of the adhesive, the adhesive entering the channels can be reduced; accordingly, it is desirable that the coating thickness be small. However, if the concavo-convex shape 74 and the machining mark 75 exist, the adhesive needs to be coated to a coating thickness that exceeds the heights of the concavo-convex shape 74 and machining mark 75. If the coating thickness of the adhesive is lower than the heights of the concavo-convex shape 74 and the machining mark 75, the substrates 70 and 71 do not adhere closely to each other since there may be gaps formed around the concavo-convex shape 74 and the machining mark 75. When a gap comes in contact with a channel, the channel width becomes wider which affects the flow of the solution.

In actuality, the concavo-convex shapes such as the concavo-convex shape 74 cannot be prevented from being formed when a plastic is molded. Furthermore, it is highly probable that machining marks such as the machining mark 75 are formed especially when the channels 72 are machined with a drill.

When the concavo-convex shape 74 and the machining mark 75 are formed, the adhesive needs to be thickly coated so as to reduce the gaps. In a known adhesive bonding process for channel devices that rely on capillary force, when an attempt is made to pass an adhesive through the channel device with the adhesive having some coating thickness, the adhesive disadvantageously enters the channels. It can be appreciated that if channels that satisfy Expression (1) are designed, the channels will be arranged close to each other such that even if the coating thickness of the adhesive is high, the adhesive entering the channels is reduced.

Accordingly, when microchannels are fabricated using an adhesive in a substrate whose surface is not uniform, more particularly, when microchannels are fabricated in a plastic substrate using an adhesive, it will be possible to relax the flatness requirement when fabricating the substrate by adjusting the distance from the wall of the channel and the coating thickness of the adhesive according to the present invention.

The present invention can be incorporated in microchannel devices for carrying out chemical reactions and chemical analyses.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-216665 filed Oct. 17, 2013, which is hereby incorporated by reference herein in its entirety.

What is claimed is:

1. A method for fabricating a channel device that is formed by bonding a first substrate having a first adhesion surface to a second substrate having a second adhesion surface, the second adhesion surface having a plurality of grooves that become channel wall surfaces, the method comprising:
a first step of forming a layer of a liquid composed of a curable adhesive between the first adhesion surface and the second adhesion surface;
a second step of forming a meniscus of the liquid in a vicinity of a wall surface of the plurality of grooves after the first step by applying a pressure to bring the first adhesion surface and the second adhesion surface close to each other; and
a third step of curing the adhesive while the first adhesion surface and the second adhesion surface are close to each other.

2. The method for fabricating a channel device according to claim 1, wherein
bonding is carried out such that the following expression is satisfied
$$L < \frac{{L}_{R} {W}_{D}^{2}}{( M + m ) g} \frac{T cos θ}{d} ,$$
where L is a distance from a channel wall to a discrete point of an adhesion layer, d is a coating thickness of the adhesion layer, T is a surface tension of a material of the adhesion layer, θ is a contact angle between the material and a substrate surface, M is a mass of a piece for applying pressure, L_{R} is a width of the piece, m is a mass of the substrate, W_{D} is a width of the device, and g is a gravitational acceleration.

3. The method for fabricating a channel device according to claim 2, wherein
a channel is arranged such that a distance from an outer periphery of the channel device to a discrete point and a distance from a channel wall to the discrete point are consistent with the expression of claim 2.

4. The method for fabricating a channel device according to claim 2, wherein
a channel through which no solution flows is arranged so as to be consistent with the expression of claim 2.

5. The method for fabricating a channel device according to claim 2, wherein
an adhesion layer that has a thickness that is greater than a height of a concavity and convexity of a substrate is used to bond a plurality of substrates with the adhesion layer in between such that the channel device is fabricated, the thickness of the adhesion layer being determined so as to be consistent with the expression of claim 2.

6. The method for fabricating a channel device according to claim 1, wherein
the second step is a step in which pressure is applied in a gradual manner such that the first adhesion surface and the second adhesion surface are brought close to each other until a meniscus of the liquid is formed in a vicinity of the wall surface of the plurality of grooves.

7. The method for fabricating a channel device according to claim 6, wherein
the second step is carried out while observing a state of the adhesive to which pressure is applied.

8. A method for fabricating a channel device that forms hollow channels in the device by bonding a first substrate having a substrate surface on which an adhesion layer is coated to a second substrate having a substrate surface in which a plurality of grooves are formed with the adhesion layer in between, the method comprising:
bonding such that the following expression is satisfied
$$L < \frac{{L}_{R} {W}_{D}^{2}}{( M + m ) g} \frac{T cos θ}{d} ,$$
where L is a distance from a channel wall to a discrete point of an adhesion layer, d is a coating thickness of the adhesion layer, T is a surface tension of a material of the adhesion layer, θ is a contact angle between the material and a substrate surface, M is a mass of a piece for applying pressure, L_{R} is a width of the piece, m is a mass of the substrate, W_{D} is a width of the device, and g is a gravitational acceleration.

9. A channel device that is formed by bonding a first substrate having a first adhesion surface to a second substrate having a second adhesion surface, the second substrate having a plurality of grooves, the channel device comprising:
a layer of a liquid composed of curable adhesive being disposed between the first adhesion surface and the second adhesion surface, the layer of the liquid being cured;
the plurality of grooves including a plurality of channels to pass a liquid therethrough, the channels having openings at both ends thereof, and a hollow groove portion having no openings at both ends thereof;
an area where the plurality of channels are arranged parallel to one another in a dense manner and an area where the channels are arranged in a sparse manner; and
the hollow groove portion being arranged between the area where the channels are arranged in a sparse manner and the channels.

10. The channel device according to claim 9, wherein
bonding is carried out such that the following expression is satisfied
$$L < \frac{{L}_{R} {W}_{D}^{2}}{( M + m ) g} \frac{T cos θ}{d} ,$$
where L is a distance from a channel wall to a discrete point of an adhesion layer, d is a coating thickness of the adhesion layer, T is a surface tension of a material of the adhesion layer, θ is a contact angle between the material and a substrate surface, M is a mass of a piece for applying pressure, L_{R} is a width of the piece, m is a mass of the substrate, W_{D} is a width of the device, and g is a gravitational acceleration.

11. The channel device according to claim 10, wherein
a channel is arranged such that a distance from an outer periphery of the channel device to a discrete point and a distance from a channel wall to the discrete point are consistent with the expression of claim 10.

12. The channel device according to claim 10, wherein
a channel through which no solution flows is arranged so as to be consistent with the expression of claim 10.

13. The channel device according to claim 10, wherein
an adhesion layer that has a thickness that is larger than a height of a concavity and convexity of a substrate is used to bond a plurality of substrates with the adhesion layer in between such that the channel device is fabricated, the thickness of the adhesion layer being determined so as to be consistent with the expression of claim 10.
